(19) United States
(12) Patent Application Publication
(10) Pub. No.: US 2014/0100917 A1
(43) Pub. Date: Apr. 10, 2014

(54) CONSUMER PREFERENCE AGGREGATION VIA AN ITEM INFORMATION SYSTEM

(71) Applicant: Kenneth J. Woolcott, Seattle, WA (US)

(72) Inventor: Kenneth J. Woolcott, Seattle, WA (US)

(73) Assignee: SIX DEGREES CAPITAL CORPORATION, Seattle, WA (US)

(21) Appl. No.: 13/492,471

(22) Filed: Jun. 8, 2012

Related U.S. Application Data
(63) Continuation-in-part of application No. 12/988,787, filed on Oct. 20, 2010.
(60) Provisional application No. 61/495,865, filed on Jun. 10, 2011.
(60) Provisional application No. 61/117,518, filed on Nov. 24, 2008.
(60) Provisional application No. 61/055,397, filed on May 22, 2008.

(51) Int. Cl. G06Q 30/02; G06F 15/16

(52) U.S. Cl. 705/7.32; 705/14.66

(57) ABSTRACT

An item information system implements a method that receives coded content at a server submitted by a plurality of users. The coded content corresponds to items of interest to the plurality of users. The coded content includes one or more of a digital file, a digital image, or an alphanumeric code. The items of interest are organized into item information lists on a per user basis. The users are able to share their items of interest with friends or acquaintances via social networking services. The item information system identifies targeted marketing opportunities by at least analyzing the item information lists of the plurality of users.

### CROSS REFERENCE TO RELATED APPLICATIONS

This application claims the benefit of U.S. Provisional Application No. 61/495,865 filed on Jun. 10, 2011 and is a continuation-in-part of U.S. application Ser. No. 12/988,787 filed on Oct. 20, 2010, which is a US national phase application of international application No. PCT/US2009/044811 filed on May 21, 2009, which claims the benefit of U.S. Provisional Application Nos.: 61/055,397 filed on May 22, 2008 and 61/117,518 filed on Nov. 24, 2008. The contents of applications 61/495,865; Ser. No. 12/988,787; 61/055,397; and 61/117,518 are all incorporated herein by reference.

### TECHNICAL FIELD

This disclosure relates generally to an item information system for advertising, marketing, informing about, reminding about, and/or selling products, services, or events and gathering information about user's interests and preferences with respect to the products, services, or events.

### BACKGROUND INFORMATION

Advertising is a form of commercial communication that attempts to persuade potential customers to purchase a particular product or service, or inform these potential customers about a company and the products or services it has to offer. Non-commercial communication may also take the form of advertising or promotion in an attempt to persuade or inform the public about events, alerts, political matters, community decisions etc. In either case, traditional advertising has used media outlets including print media (e.g., magazines, newspapers, billboards, posters) and broadcast media (e.g., radio, television). While traditional advertising media has the ability to reach large numbers of potential customers for a reasonable price, it has not been particularly actionable, memorable, or measurable. From the potential customer's perspective, traditional advertising is not always actionable at the initial point of interest or at the initial time of interest. When presented with a traditional advertisement, such as, a magazine ad, a billboard, a radio ad, or television ad, the potential customer is not able to act on their curiosity to obtain more information or even purchase the advertised item. Similarly, unless the advertisement is particularly creative, these traditional advertisements do little to remind the potential customer to follow up on their initial interest in the item. The point of interest is often lost and does not directly translate to the point of sale. There are many barriers to the effectiveness of traditional advertising, including, the inability to effectively time-shift decision making about an initial interest and the inability to easily shift the evaluation of that initial interest in the often fleeting or one dimensional advertisement exposure to a more multi-dimensional environment such as the rich information gathering and networking possible on the Internet. For example, a customer interested in a product at the point of reading an advertisement may either forget an associated 800 number and/or the URL, fail to copy them down, not have immediate access to a computer, or simply not be inclined to access a URL or dial a toll free number at that particular time.

From the advertiser's perspective, traditional advertisements are relatively un-measurable to determine whether the advertisement dollars were well spent. Metrics on advertising effectiveness are highly desirable, but often challenging and expensive to obtain, if at all achievable. As such, traditional advertisement media cannot easily or efficiently inform the advertiser whether or not a particular advertisement strategy, placement, or campaign should be continued, repeated, or dropped.

Consequently, nontraditional advertising using the Internet has been gaining market share, since the arrival of companies like Google™ and Yahoo!™. An Internet based advertisement is able to provide immediate and actionable follow up information at the initial point of interest by virtue of the potential customer's simple click of a mouse. Click-through advertisements are easily measured to provide feedback to the advertiser to determine whether their ad dollars are well spent.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. The drawings are not necessarily to scale, emphasis instead being placed upon illustrating the principles being described.

FIG. 1 is a diagram illustrating a dataflow environment for operation of an item information system, in accordance with an embodiment of the disclosure.

FIG. 2 is a functional block diagram illustrating components associated with an item information system, in accordance with an embodiment of the disclosure.

FIG. 3A illustrates information stored in a user table and an item table, in accordance with an embodiment of the disclosure.

FIG. 3B illustrates information stored in an advertiser table and a transaction log, in accordance with an embodiment of the disclosure.

FIG. 4 is a flow chart illustrating a process for aggregating user interests to identify potential marketing opportunities, in accordance with an embodiment of the disclosure.

FIG. 5A is a flow chart illustrating a process of determining when to solicit discount offers from providers, in accordance with an embodiment of the disclosure.

FIG. 5B is a flow chart illustrating a process of determining when to solicit discount offers from providers, in accordance with an embodiment of the disclosure.

FIG. 6 illustrates an advertiser display page containing item information and links to related items, in accordance with an embodiment of the disclosure.

FIG. 7 is a block diagram illustrating a user display page that functions as a sort of consumer queue or personalized collection, in accordance with an embodiment of the disclosure.

### DETAILED DESCRIPTION

Embodiments of a system and method for consumer preference aggregation using an item information system are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The techniques disclosed herein utilize an item information system to aggregate consumer demand and preferences, whereby consumers express interest (either expressly or implicitly) in an item (e.g. product, service, or event) presented by advertisers. The item information system enables the consumers to share and express their interest in the items with others to leverage social networks and increase the aggregate demand. The consumer interests may then be analyzed to generate affinity data indicative of the consumer demand for particular items, and the aggregated consumer demand used to solicit offerings (e.g., discount offerings, limited offerings, information offerings, or otherwise) from providers of the items of interest.

In some embodiments, the offers are provided to the users (potential consumers) of the item information system only after a threshold number of the users have expressed interest in a given item. Traditionally, marketing or special offers are generated by brands or brand providers and used to generate consumer interest in the goods or services. In contrast, embodiments disclosed herein put the consumer in control and drive the selection of offerings to be solicited from the brand providers. The item information system works on behalf of the users to negotiate volume offerings.

The present invention provides a method and system for aggregating a number of potential or committed consumer preferences regarding an item, event, or service, utilizing an item information system. In one embodiment, the product, event, or service may be provided as a conditional offer based upon a minimum pre-set quantity of potential consumers who have expressed interest utilizing the information system. In another embodiment, the product, event, or service may be provided as a conditional offer based upon a minimum pre-set quantity of committed consumers who have expressed interest and/or commitment utilizing the information system. In another embodiment, the product, event, or service may comprise a multi-staged conditional offer based upon the ultimate quantity of committed consumers who have expressed interest and/or commitment utilizing an information system. In another embodiment, the committed consumers may prepay for the conditional offer and have their payment returned if the condition is not met. In another embodiment, the committed consumers may have their payment information, including but not limited to a credit card, debit card, bank account transfer, bank account withdrawal, or other account, stored in the database of the item information system, with permission to extract a payment if the sale condition is met. Instead of being stored in the database of the item information system, the payment information may be managed by a third party. Alternatively, in another embodiment, the item, event, or service may be presented to potential consumers using terms that are not definite, so that the definitive offer is not presented until the ultimate number of potential or committed consumers, measured at a pre-set point in time, is determined using the present method and system. In another embodiment, the user demands may be aggregated according to users' expressed interest in an item including an expressed willingness to pay a particular maximum price in conjunction with a conditional offer, indefinite offer, or interest in an item in the absence of an offer. In any of these embodiments, a maximum time limit may be set to reach the set condition. In any of these embodiments, a maximum number of offers may be preset by the offeror or item information system.

In another embodiment, a user interested in an item is able to utilize the item information system described herein by submitting to the item information system, via a computer terminal or mobile communication device, a keyword or code relating to an item. The item information system will provide to the user any and all existing offers for items that are related to the keyword, using a searching method, such as, for example only, a text search of the word submitted by the user, combined with a search for words that are included in the system on a list of words to be searched whenever any of the words on the list are searched. If no offer for an item or related item is present in the item information system when the search is performed, the request from the user is noted by the item information system. When an item related to the noted search later enters the item information system, the user is contacted regarding the item. The item may enter the item information system by coincidence, or, for example only, by approaching the merchant with a request for a discount on a sale of the item to the list of interested users, which the merchant then creates and enters into the item information system as an offer. This solicited offer may be provided only to the list of interested users, or also made available to all users of the item information system.

In another embodiment, a user with location based service (stemming from, for example only, a mobile communication device or from the manual entry of a location name or zip code) is able to utilize the item information system described herein by submitting to the item information system a keyword or code relating to an item with a geographical context. For example only, a user may enter the word “Pizza” into the system and the system will present the user with any and all offers related to the keyword or code entered that are currently available in that geographic area. Additionally, the item information system may note geographically dependent keyword or code submissions, whether or not an offer is present in the item information system, and approach merchants that offer items related to the submitted keywords or codes within geographical areas in order to request a discount on the sale of the items. The merchant may then create an offer and enter it into the item information system for the selected geographical locations.

In any of the present embodiments, a user may interact with the item information system utilizing a mobile device application, such as a computer software program designed to convey user inputs to the item information system and/or receive information, database search results, or other data. The mobile device application may receive data from the item information system either solicited by the user or unsolicited, for example only as push data. The user may alternatively utilize the mobile device's existing software, such as the SMS (Short Message Service) or MMS (Multimedia Messaging Service) software, internet browser, and the like. User inputs may include audible speech, input of numbers and/or characters, images, touch-screen interaction, and the like.

The present method and system utilizes an item information system such as that described in U.S. application Ser. No. 12/988,787 filed on Oct. 20, 2010, which is a national phase filing of International Patent Application Number PCT/US2009/044811, filed on May 21,2009, both of which are fully incorporated herein by reference. Embodiments of a method and system for providing information about items, such as products, services, and events, using item codes that are distributed via advertisements and received into the information system are described herein.

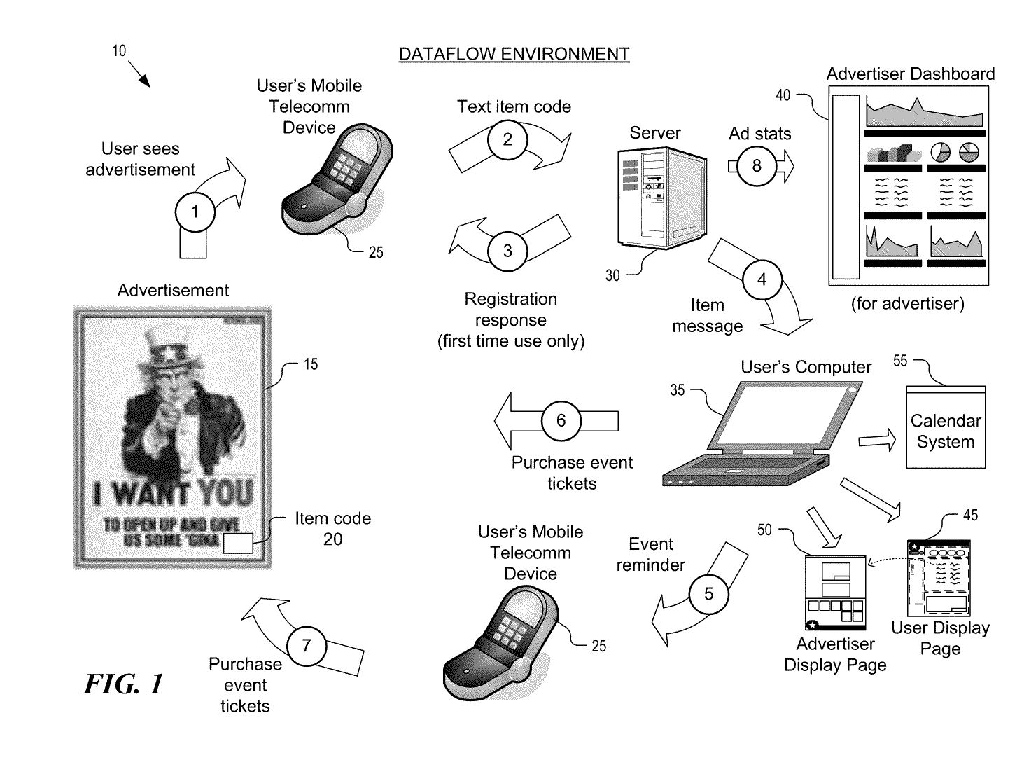

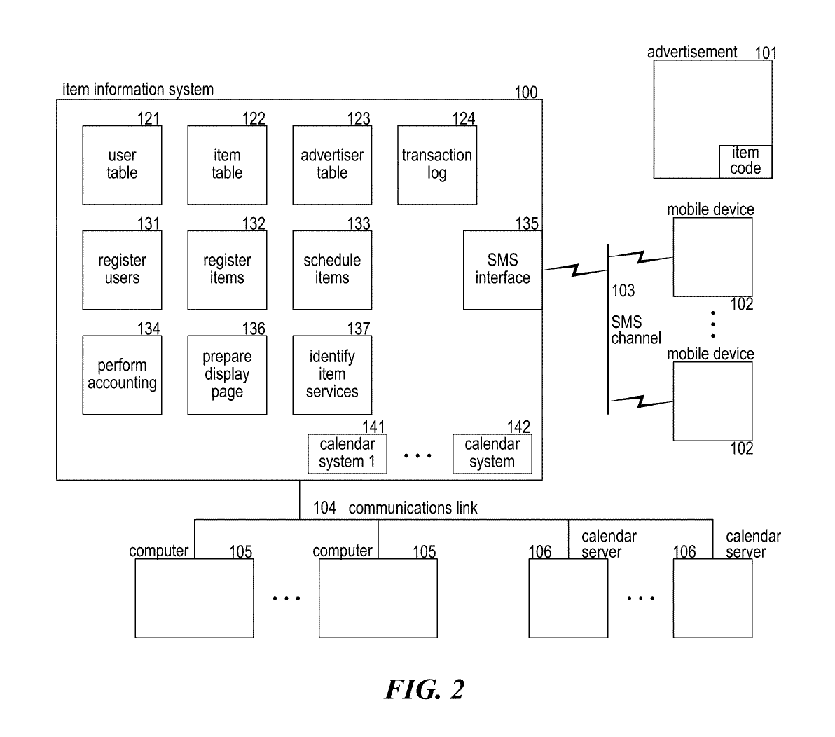

FIG. 1 is a diagram illustrating a dataflow environment 10 for operation of one embodiment of an item information system. The illustrated embodiment of environment 10 includes a traditional advertisement 15 brandishing an item code 20, a mobile telecommunication device 25, a server 30, a user web browser enabled device 35, an advertiser dashboard 40, a user display page 45, an advertiser display page 50, and a calendar system 55. The item information system (e.g. item information system 100 illustrated in FIG. 2) is installed on server 30 to facilitate actionable, memorable, and measurable advertising placements and techniques. Server 30 may also be utilized to store consumer data such as demographics, psychographics, bio data, profession, location, or other information that the consumer voluntarily provides or which is available in the public record. This data stored on server 30 about consumers who have utilized the item information system described herein may be provided to advertisers and manufacturers to aid the tailoring of marketing campaigns, point out areas of weakness and strength, and generally provide useful information regarding their markets or potential markets.

At arrow 1 in FIG. 1, a user sees an advertisement 15 for an item. The item may comprise an event, a product, and a service, while advertisement 15 may be conveyed using any number of advertising mediums or multiple mediums, including but not limited to a magazine, a newspaper, a billboard, a poster, the radio, the television, the internet, etc. Advertisement 15 is coded, marked, or otherwise brandishes item code 20. Item codes 20 may also be referred to as Ad Codes, as it is possible that the same item may be given different codes based on segments of media or unique placement of advertisement 15. Advertisement 15 may also be audibly marked with item code 20. If advertisement 15 is related to a promotional event, then item code 20 may be referred to as an event code. If related to a product, item code 20 may be referred to as a product code. If related to a service, item code 20 may be referred to as a service code. Item code 20 may take any number of forms, including but not limited to numbers (e.g., phone number, serial number, etc.), characters (e.g., words, etc.), alphanumerical codes (e.g., a URL, web address, etc.), optical information such as images or graphics (e.g., bar code, QR code, etc.), audible sounds, radio frequency identification, or other forms that identify the offer.

Upon seeing advertisement 15, the user can input item code 20 into a mobile telecommunication device 25 if the user desires additional information or desires to shift further evaluation of the item to a later time. In one embodiment, the user can input item code 20 into a mobile telecommunication device 25 if the user desires to show interest in a conditional or indefinite offer presented by the advertiser. In another embodiment, the user can input item code 20 into a mobile telecommunication device 25 if the user desires to show commitment to purchase the item if the conditional or indefinite offer becomes a definite offer.

Item code 20 may take various forms and formats as discussed herein; however, in one embodiment, item code 20 is a short and memorable alphanumeric code which the user texts (See FIG. 1, arrow 2) to a system number associated with the item information system operating on server 30. In one embodiment, the system number is also included in advertisement 15 with item code 20. In some embodiments, the item codes 20 may additionally be delivered to server 30 via the user directly inputting the item code 20 into a webpage hosted by server 30 or via a link related to an online advertisement. Note that the item code 20 could be verbally shared from one user to another in the absence of advertisement 15 (not shown). Advertisement 15 and item code 20 may also be shared together or independently in a variety of ways (for example only): orally, via email or networking websites, or by the user allowing the user account to be linked with other user accounts, as discussed further herein. In another embodiment, item code 20 can be alphanumerical codes, optical codes, or any other codes or keywords used in other information systems or schemes, which the item information system 100 connects to an item via a variety of means, for example only, a list created by research of advertisements providing codes for other information systems or schemes.

In another embodiment (not shown), upon seeing advertisement 15, the user can submit a digital image of the item code 20 (e.g., using image recognition techniques) on a mobile telecommunication device 25 via MMS (Multimedia Messaging Service), or another communication service, to a system number or an Internet based address, associated with the item information system operating on server 30. Upon receipt of a digital image, the item code 20 is delivered to the item information system operating on server 30. Item codes 20 can be delivered to item information system via automated means (such as computerized character recognition) or manually delivered to server 30 by a human input. Wherever a text message is utilized for item code 20 submissions, MMS or other communication services may be substituted.

In another embodiment (not shown), upon seeing advertisement 15, the user can submit an item code 20 via voice recognition software on the user's mobile telecommunication device 25 which can translate speech into text, which may then be submitted to the item information system 100 via SMS (Short Message Service) or other application. Thus, coded content (e.g., item codes) may be captured on a per user basis at the item information system installed on server 30 using a variety of different techniques as described above.

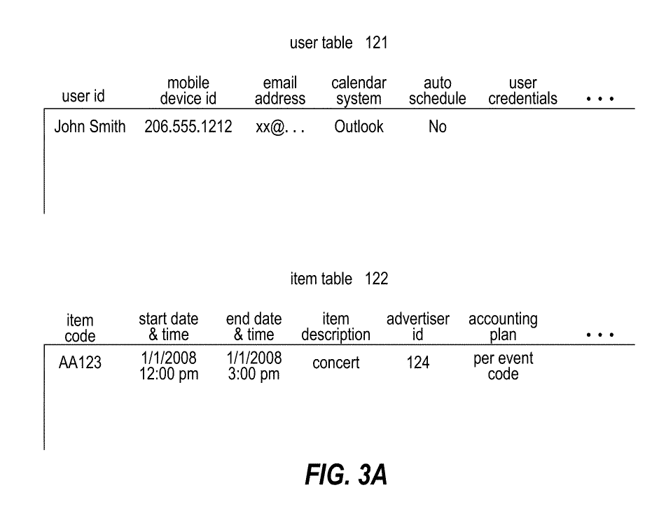

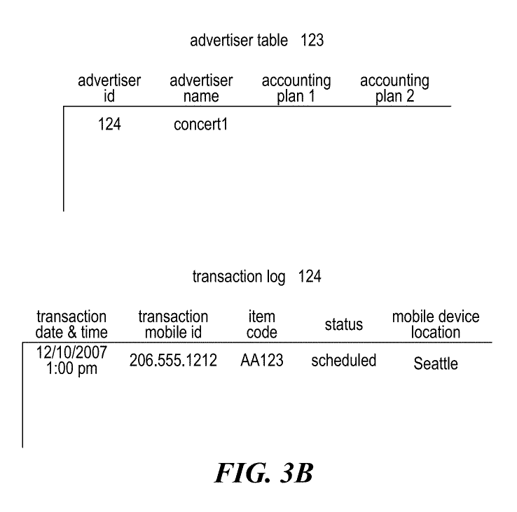

In one embodiment illustrated in FIG. 1, if the text message is the first time the user has interacted with the item information system, then a registration response message (arrow 3) is sent back to the user's mobile telecommunication device 25 soliciting user information, such as that described in user table 121 of FIG. 3A. Alternatively, the registration response may include instructions or a hyperlink for accessing a webpage to setup the user account. For subsequent item code 20 entries after the user has been enrolled, the user information is recalled from memory on the server 30 utilizing a user identifier embedded in the text message (e.g. user's phone number) or utilizing the user's user account information if item code 20 is entered via the user account.

As further described in FIG. 1, after the user is registered and an item code 20 received (see arrow 2) by the server 30, the item information system may send an item message (arrow 4) to the user's web browser enabled device 35 (e.g. personal computer, workstation computer, tablet computer, smart phone with web browser functionality, etc.). In one embodiment, this item message (arrow 4) may be posted to a user display page 45 associated with the registered user's user account. The registered user may select as a preference to also receive the item message (arrow 4) by return text message or by email. In one embodiment, the item message (arrow 4) includes a calendar request for scheduling a calendar event with the calendar system 55 installed on the user's web browser enabled device 35, for example only an event such as a concert or store sale. The item message (arrow 4) may also include information necessary to configuring calendar system 55 to remind the user at a future date (arrow 5). In one embodiment, the item message (arrow 4) may include a hyperlink to advertiser display page 50 including a representation of advertisement 15 and related or other selected information or a hyperlink to user display page 45 including a queue of item entries corresponding to recently submitted item codes 20. In one embodiment, the item message (arrow 4) may further include direct hyperlinks to a website of the host of the item where electronic coupons, other offers, and/or further detailed information are provided. These links may also be embedded in advertiser display page 50.

In one embodiment, the item message (arrow 4) is sent in response to the user logging into a website of the item information system, such as the user account, to access user display page 45. The user can access item information via a browser enabled mobile communication device or via a desktop, laptop, or tablet computer. In this embodiment, server 30 posts the item to a user account via user display page 45 in response to the user submitting the item code (arrow 2). Upon logging into the website to access user display page 45, server 30 delivers the item message (arrow 4) to the screen of the user's web browser enabled device 35. User display page 45 may include an item list of recently submitted item codes 20 to allow the user to review a chronological list of past submissions. As the user builds a queue of item entries, the user can view the individual advertisements and related item information by selecting a particular item entry in the item list located on user display page 45. In this manner, user display page 45 represents a personalized list or personalized collection of items of interest to the given user. Selecting an item entry may cause the item information system to deliver another item message (arrow 4) containing advertiser display page 50 to the user's web browser enabled device 35. User display page 45 may also include, either together with the item codes 20 or on a separate list, user submissions of items of interest in the absence of an offer, or keywords or codes submitted by the user. In one embodiment, advertiser display page 50 includes a representation of advertisement 15 along with additional information and links to related services, products, or events. From either a web browser enabled device 35 or user mobile telecommunication device 25, the user may elect to share the user's entire queue of entry items, or selected portions of the queue of entry items, with other users that the user links the user account to. This information may also be shared via an election to submit the item queue or individual item code 20 to the user's social networking website account, personal website, or a link to be included in an email from the user.

Further illustrated in FIG. 1, as text messages with various item codes 20 from multiple users arrive at the item information system, advertisement statistics are collected and summarized into an advertiser dashboard 40 (arrow 8). Advertiser dashboard 40 provides each advertiser using the item information system with unique, real-time, measurable results of the efficacy of their advertisement campaigns. Categories of information desired by the advertiser regarding the users may be predefined by the advertiser and calculated and stored on server 30 to be presented in the advertiser dashboard 40. Examples of categories of information may include the location of the advertisement 15 based on its unique item code 20, the GPS location of the user input, user demographic information such as workplace or home region, psychographics, bio data, profession, committed or interested status, whether the user account is linked to other user accounts, the quantity of linkage to other users, the frequency that the user recommends the item to other linked users or to the user's networking website, the frequency that the user has viewed the item in the user's account, which of the provided additional information and links to related items the user has selected to view, etc.

FIG. 2 is a functional block diagram illustrating components associated with an item information system 100. The components associated with the item information system 100 may include advertisements 101, mobile devices 102, SMS channel 103, communications link 104, user computers 105, calendar servers 106, and an item information system 100. Each advertisement 101 includes an item code 20 (FIG. 1) that is registered with the item information system 100. Users submit the item codes 20 (FIG. 1) via mobile devices 102 as text messages that are transmitted via the SMS channel to the item information system 100. The item information system 100 sends calendar requests where desired via the communication link 104 to the user computer systems 104 and calendar servers 106 of the users. The item information system 100 also interfaces with computer systems of advertisers for registering advertisers and items and providing accounting and statistical information as discussed herein.

The item information system 100 includes a user table 121, an item table 122, an advertiser table 123, and a transaction log 124. The user table 121 contains user information obtained during registration of users, such as described above. The item table 122 contains item information obtained during the registration of items. The advertiser table 123 includes advertising information obtained during registration of advertisers. The transaction log 124 contains an entry for each item code 20 (FIG. 1) submitted to the item information system 100. The item information system 100 also includes a register users component 131, a register items component 132, a schedule items component 133, an accounting component 134, an SMS interface component 135, a prepare display page component 136, and an identify item services component 137. The item information system may also include calendar system components 141 and 142 that provide logic for generating calendar requests for specific calendar systems.

FIG. 3A illustrates information stored in a user table and an item table in some embodiments. The user table 121 may include a unique user identifier, a mobile telecommunications device identifier, an email address of the user, item codes (not shown), etc. The item table 122 may include an item code 20, a location, a start date and time, and end date and time, an item description, a unique advertiser identifier, a unique user identifier (not shown), etc. Information stored in the user table 121 and the item table 122 may be linked by cross reference or other means. For example only, each item code 20 in the user table 121 may be cross-referenced to the same item code stored in the item table 122. For example only, each unique user identifier in item table 122 may be cross-referenced to the same unique user identifier associated with the user table 121. The item table 122 may also include non-system codes or keyword searches submitted by the user. Additionally, a second item table 122 may be created exclusively containing any non-system codes and keyword searches submitted by the user (not shown).

FIG. 3B is a block diagram that illustrates information stored in an advertiser table and a transaction log in some embodiments. The advertiser table 123 may include a unique advertiser identifier, an advertiser name, etc. The transaction log 124 may include a transaction date and time, a mobile telecommunication device identifier, an item code 20, a status code, a mobile device location, a unique user identifier, etc. The item information system 100 may add a new record to the transaction log 124 each time a particular item code 20 is submitted. In some embodiments, the item information system 100 may create a transaction log 124 containing nonitem code 20 entries, such as keyword searches and/or entries of other system codes not in the item information system 100 (not shown). The item information system 100 may create a separate transaction log 124 (not shown) containing non-item code 20 entries, such as keyword searches and/or entries of other system codes not in the item information system 100. Information stored in a transaction log 124 may be linked by cross-reference or other means to user accounts, unique user identifiers, or other information stored in a user table 121 or item table 122.

In one embodiment, the item information system 100 described herein may be utilized with a purchasing model whereby the product, event, or service may be provided as a conditional offer based upon a minimum preset quantity of potential consumers. As an illustration of this embodiment, FIG. 1 advertisement 15 may be a conditional offer for an item at a discounted price if, for example only, a threshold of 500 or more users express their interest in the offer within, for example only, a one week period of time. The offer may be constructed with greater or fewer than the example 500 user threshold, and/or with greater or less time limit than the example one week, prearranged by the offeror, with no preferred embodiment.

The number of interested potential or committed consumers may be measured utilizing a software program with data input from server 30 from the transaction log 124, for example. The number may also be measured by the use of a software program that examines the user account information or user display page 45, for example. The number may also be measured by providing the item table 122 on server 30 with a counter, for example.

When the item information system 100 registers the prearranged threshold amount of users upon the completion of the prearranged length of time, the information system 100 may automatically alert the users who expressed interest in the conditional offer that the threshold has been reached within the time limit and the condition of the offer has been met. The automatic notification may include the mechanism to approve the purchase whereby consumers have their payment information, including but not limited to a credit card, debit card, bank account transfer, bank account withdrawal, or other account, stored in the database of the item information system (or managed by a third party), with permission to extract a payment when user approval is given. The automatic notification may use the methods described herein for registration response (FIG. 1, arrow 3), item message (FIG. 1, arrow 4), email, and/or an alert on user's account/user display page 45 (FIG. 1). The mechanism to approve the purchase may be provided as a link within the automatic notification email or alert on user display page 45, or it may be provided as receiving a return text message reply to the automatic notification which grants the permission to extract a payment when the reply text is received by item information system 100.

In another embodiment, the present method and system may apply to committed consumers rather than potential or interested consumers, as described herein. At the user's preset election, the purchase may occur automatically using payment information data stored on server 30, or managed by a third party, upon the conditions of the offer being met, without additional action by the user. Further embodiments obtain a pre-payment, a deposit, or a guarantee for payment for the product with each item code 20 submission. In addition, further embodiments set a cutoff date by when the number of committed or interested consumers must reach a predetermined minimum number or the condition of offer is not met and the purchase transaction is automatically cancelled or refunded.

The user may have to option to connect via server 30 the user's account with other user accounts whereby the users who are connected will see the entire or partial item table 122 (FIG. 3A) of each connected user. The user may have the option to invite connected users to join the list of potential or confirmed consumers for an offer, or join in the list of users who express interest in an item in the absence of an offer, via the item information system 100. The user may have the option to invite others to join the offer or the list of interested users via networking websites, personal website, or by creating a link to be emailed by the user.

In one embodiment, users may have their information, such as such as demographics, psychographics, bio data, profession, location, etc. collected by the item information system 100 and grouped based on the history item codes 20 submitted by the user. In another embodiment, this information may be provided to the advertisers whose item codes 20 were submitted, or to other advertisers who may be interested in examining the data of users utilizing the item information system to accept offers or to show their interest in an item.

### EXAMPLE 1

A conditional offer may be presented using the item information system to users whereby the condition is met when a preset quantity of interested or committed consumers is reached. For example, a concert promoter may create a conditional offer in a particular city/location if enough users show interest in or commitment to purchase a ticket to the concert via the item information system between a beginning and end date. For another example, a conditional offer of a wine tasting dinner may be activated at a particular venue if enough users show interest or commitment to attend the dinner via the item information system between a beginning and end date.

### EXAMPLE 2

A multi-staged conditional offer may be created using the item information system whereby an item is offered to users at 10% off retail price if 1000 users express interest or commitment utilizing the item information system between a beginning and end date, a 20% off retail price is offered to users if 1500 users express interest or commitment utilizing the item information system between a beginning and end date, and 30% off retail price is offered to users if 2000 users express interest utilizing the item information system or commitment between a beginning and end date.

### EXAMPLE 3

A conditional offer may be created using the item information system based on the number of occurrences where a user recommends an offer to other users via email, a networking website, or other identifiable referral method. For example, a user may create a link on his social networking website recommending a particular offer using the item information system, and send out 15 emails to the user's email contacts to meet the condition for the offer. Additionally, a conditional offer may be created based on a number of recommendations that result in a different user accepting an offer for an item or expressing interest in an item via the item information system.

### EXAMPLE 4

Users perform searches in the item information system for offers to sell discounted pizza deliveries located within a particular neighborhood. No discounted pizza delivery offer exists in the system for that neighborhood at the time of the searches. Each search is logged in the item information system, and the number of occurrences including unique user identifiers is measured. When a number of searches, for example only, 50 search occurrences for pizza are performed within a time period, for example only, a two-month period, the pizza delivery merchants within that neighborhood are contacted with the information that 50 unique searches for offers have been performed within two months and that the merchant may create an offer for pizza using the item information system.

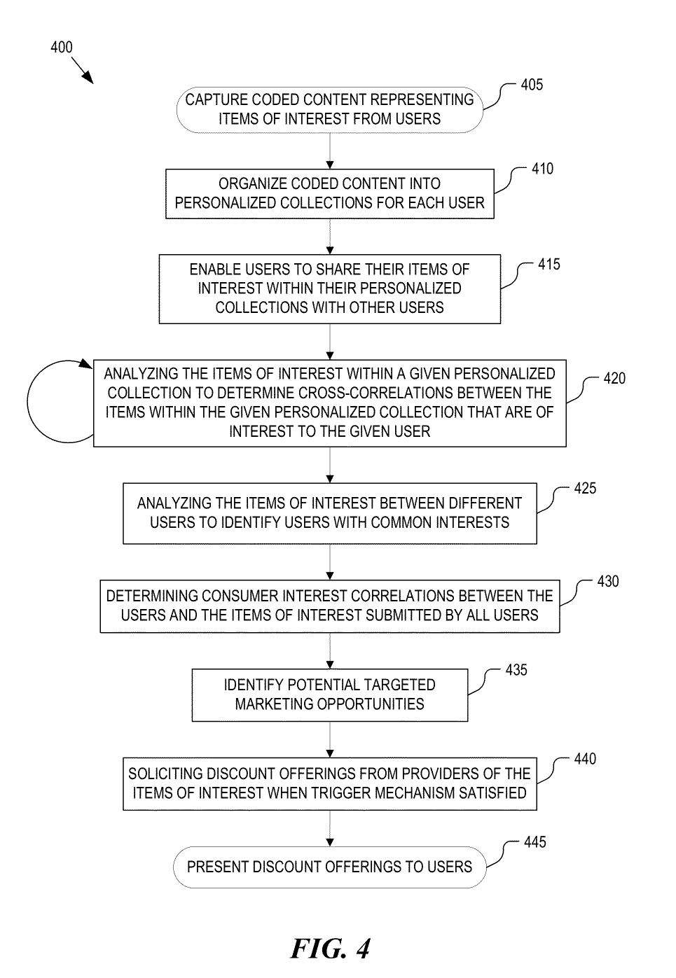

FIG. 4 is a flow chart illustrating a process 400 for aggregating user interests to identify potential marketing opportunities, in accordance with an embodiment of the disclosure. The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel.

In a process block 405, coded content representing explicit or implicit items of interest of the users is captured. As discussed above, this coded content is captured on a per user basis and may be item codes (e.g., item code 20) submitted via text message, email, or input via a website. The coded content may further includes items referenced in messages sent between friends recommending a particular item or even direct requests for group discounts of a particular item presented to the item information system 100 by the users. The item codes may relate to advertisements for a particular item of interest (e.g., product, service, or event) or the coded content may be various depictions or descriptions of the items of interest.

In a process block 410, item information system 100 organizes the coded content into personalized collections (e.g., item table 122, item list region 901, etc.) for eash user. These personalized collections are item information lists that may take the form of a textual or graphical list or be more freeform such as a collage. The personalized collections may be private lists accessible only to the user. In one embodiment, the user may make their list fully public or even share their personalized collection with selected friends or acquaintances (process block 415). Sharing may be provided via a proprietary messaging services enabled internal to item information system 100 or may be shared using various third party social networking services.

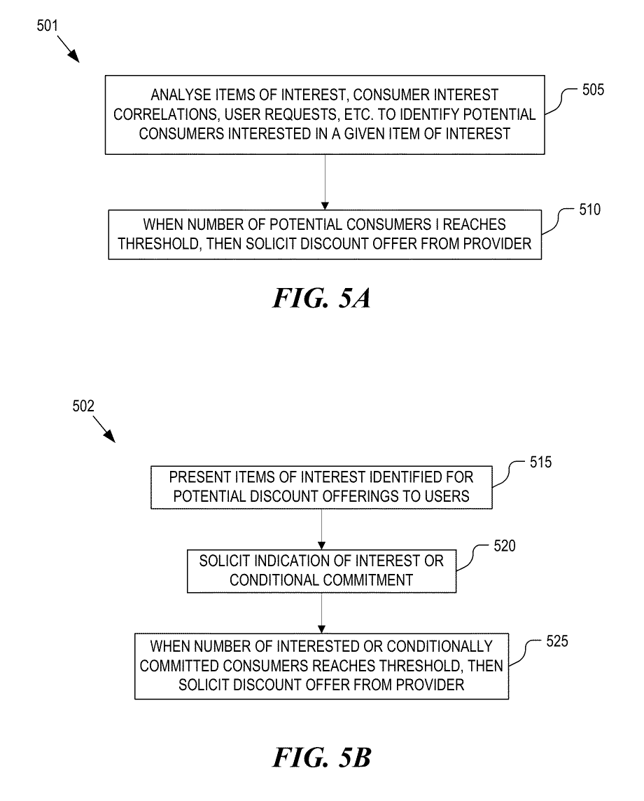

When a user adds items of interest to their personalized collections, these collections may be view as affinity data indicating the user's interests. Once a given personalized collection associated with a given user has been populated with a number of items of interest, the personalized collection can be analyzed to determine cross-correlations between the items of interest within the specific personalized collection (process block 420). For example, if the user has added a pair of pants by Brand X and a shirt by Brand Y, then correlations between the specific pants and the specific shirt, between the type of pants and the type of shirt, between the two Brands X and Y, or some combination thereof, may be identified. When different users add the same or similar items to their respective personalized collections, the personalized collections can be cross-analyzed (process block 425) to identify cross-correlations between the user themselves and between the items of interest in the different personalized collections (process block 430). The above correlations may be useful for identifying potential marketing opportunities targeted to the various users that share common interests as identified by the above correlations (process block 435). A number of techniques, as discussed above and below in connection with FIGS. 5A and 5B, may be used to aggregate the users' common interests to connect large groups of otherwise unrelated interested consumers with providers willing to provide discount offerings for larger volume orders.

Once a potential marketing opportunity has been identified, one or more providers of the items of interest may be solicited to provide a volume discount offering. These discount offerings may be offered based upon an analysis of the demographic information collected for the users, the personalized collections, or explicit/implicit feedback from the users indicating items that may sell in sufficient numbers if a discount offering were provided. In one embodiment, the discount offer is solicited from the provider with an indication of how many potential users are interested in their item. In one embodiment, the discount offer may be solicited from the provider with an indication of how many users have provided a conditional commitment to purchase the item of interest pursuant to a discount offering. In one embodiment, a multi-stage discount offer may be solicited from the provider with an indication of how many users have expressed interest in a particular item of interest at various different discounts (e.g., 20% off, 30% off, 40% off, etc.). If a vendor agrees to provide a discount offering, then in process block 445 the discount offering is offered to the users. In one embodiment, the discount offering is an opt-in offering provided to the users and held open for a limited period time and/or until a limited number of items are sold. In one embodiment, the discount offering is limited to a specific geographical location and only offered to those users registered in the relevant geographical area. The discount offerings may be offered up to all users, or targeted only to those users deemed likely to have an interest in the discount offering based upon explicit/implicit expressions of interest (e.g., the offered item has been added to their personalized collection by themselves or a friend, or they have otherwise expressed an interest) or the above cross-correlatoins suggest a particular user would be interested in the discount offering.

FIG. 5A is a flow chart illustrating a process 501 for determining when to solicit discount offers from providers by transparently analyzing affinity data, in accordance with an embodiment of the disclosure. In a process block 505 the user demographic data and/or user affinity data determined from analyzing the user correlations and item correlations is used to identify potential consumers interested in a given item of interest. In one embodiment, item information system 100 provides a forum for users to explicitly request discount offerings for a given item of interest. When the number of potential consumers (interested users) in a particular item of interest reaches a threshold number, then a discount offer is solicited from one or more providers of the item (process block 510). In one embodiment, the discount offer solicitations may be automated solicitations sent to enrolled providers via electronic means (e.g., email).

In some embodiments, process 501 operates to transparently analyze the users and the users' affinity data to determine what items may sell well if a discount offer were provided. In some embodiments, item information system 100 operates transparently to divine what the users want and engages providers of the desired items on behalf of the users to achieve volume discount offerings. Thus, when the user's create their personalized collections, they are in essence telling item information system 100 what are their interested and what they want. From this affinity data, the system operates in the background on their behalf to obtain discount offerings related to the items for which they have implicitly/explicitly expressed interest. Item information system 100 may be thought of as a personal concierge that works to make items the system either knows or believe the users would want available at discounted prices. Once the discount offers are made available, the users need only opt-in pursuant to the terms of the discount offer.

FIG. 5B is a flow chart illustrating a process 502 for determining when to solicit discount offers from providers based upon apparent interactions with the users, in accordance with an embodiment of the disclosure. In process 515, item information system 100 presents items of interest to the users that are being considered for a potential discount offering. In one embodiment, the items presented may be based, at least in part, upon analyzing the user affinity data to obtain a preliminary indication of items that are likely to sell well if a discount offering were presented to the users. A number of items may be presented to the users on a continuous, but temporary basis with the list of presented items being periodically updated. In one embodiment, the items are presented on an electronic bulletin board or list(s) of the items made otherwise accessible to the users via item information system 100.

In a process block 520, when the items are presented to the users, item information system 100 solicits either an explicit indication of interest and/or a conditional commitment to purchase an item. The conditional commitment may represent a commitment to purchase the item pursuant to a discount offering. The conditional commitment may be conditioned upon satisfying a number of conditions including one or more of: obtaining a specific group price or group discount from a provider, making the discount offer available within a fixed period of time, obtaining a fixed number of conditional commitments, or otherwise.

In a process block 525, once a threshold number of users have either express interest in an item or agreed to a conditional commitment to purchase the item pursuant to a discount offer, the item information system 100 solicits a provider of the item to offer the discount offer, or offer a similar discount offer. In one embodiment, item information system 100 solicits multiple providers to provide competing discount offers. In one embodiment, only one of the competing discount offers is selected for offer to the users of item information system 100.

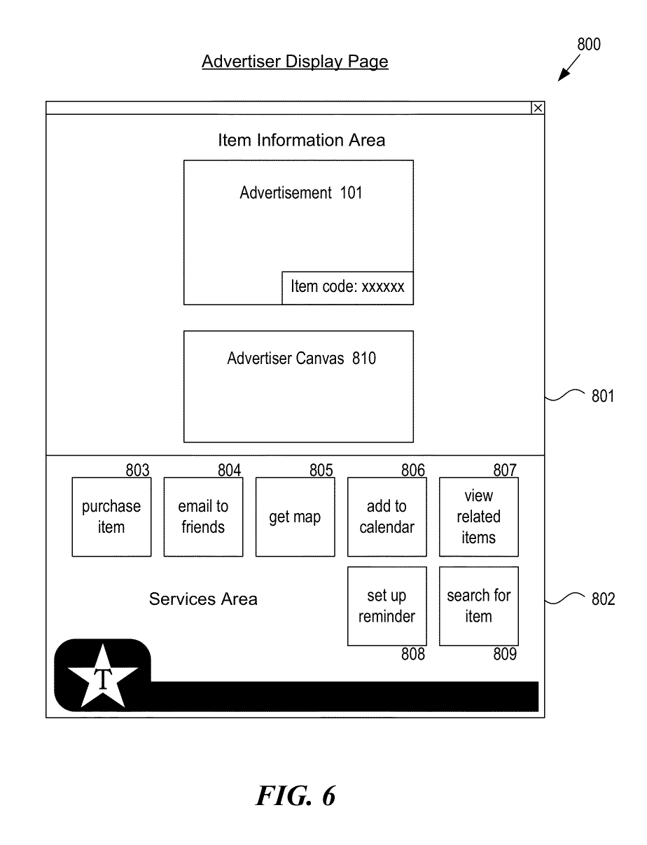

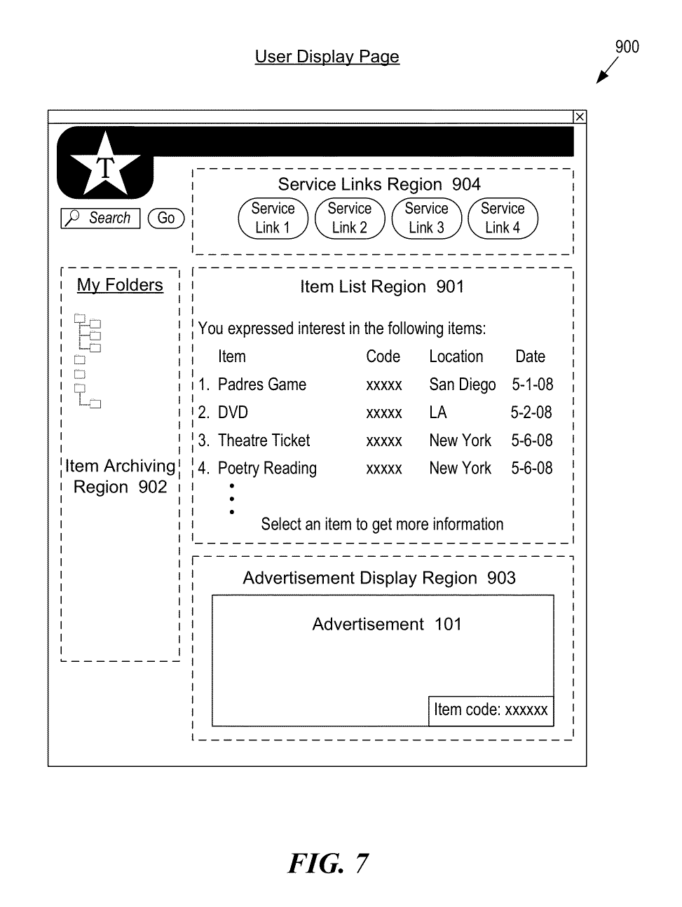

FIGS. 6 and 7 illustrate various aspects of item information system 100, in accordance with some embodiments. FIG. 6 illustrates an advertiser display page 800 containing item information and links to services. Advertiser display page 800 is one possible embodiment of advertiser display page 50, illustrated in FIG. 1. Advertiser display page 800 may be displayed when a user selects a link within an electronic mail message sent to the user in response to the user entering an item code. The advertiser display page or item information page includes item information area 801 and services area 802.

The item information area contains information describing the item that is associated with the item code that the user entered. For example, the item may be an event, service, or product. The illustrated embodiment of item information area 801 includes a re-rendering (or modified representation thereof) of advertisement 101 (e.g., advertisement 15 in FIG. 1) originally seen by the user and advertiser canvas 810. Re-rendering advertisement 101 within item information area 801 provides a visual cue that reminds the user of the original advertisement that peaked the user's interest. Advertiser canvas 810 is a convenient location for the advertiser to provide additional information related to advertisement 101 to the user/consumer and may be used to link to virtual coupons or other promotions.

Advertiser canvas 810 is positioned in proximity to the reproduction of the original ad of interest (e.g., advertisement 101). Advertiser canvas 810 operates as a portal of communication between the advertiser and the registered user who represents a potential customer specifically interested in the advertisers wares. In one embodiment, advertiser canvas 810 is hosted by the item information system, but accessible and managed by the particular advertiser. This embodiment affords the advertiser the opportunity to communicate directly to their best potential customers with special offers, updates, discounts, promotions, etc., as long as, the user continues to retain the particular advertisement in their consumer queue (e.g., item list region 901).

The services area contains links 803-809 that can be clicked-through to services associated with the item. The links are to services and may be implemented as an HTTP request to retrieve a web page, a code that is executed as part of the display page (e.g., web widget), and so on. The services may be enabled or disabled or shown or not shown depending on the type of item. For example, if the item is a theatrical event, then the purchase item service 803 may represent a link to Ticketmaster.com that is passed a code representing the event. When the user selects the purchase item service, the Ticketmaster.com web page may be displayed with information relating to the theatrical event. The get map service 805 may represent a link to MapQuest.com that is passed the address of the theatre. As another example, if the item is a book, then the purchase item service may represent a link to Amazon.com that is passed the stock keeping unit (“SKU”) of the book. In this example, the map service may be disabled or may represent a link to MapQuest.com that is passed an address of a bookstore in the hometown of the user or near the current location of the user if current location information is available. The add to calendar service 806 may be disabled or may represent a link resulting in a book signing by the author being added to the user's calendar. In some embodiments, the parameters (e.g., SKU or theatre information) for the services may be passed as data of a display page that is not displayed to the user (i.e., hidden information). Services area 802 may also include links to social networking websites (e.g., Facebook, Linkedin, MySpace) to enable the user to quickly share the item with their friends and acquaintances. The service links displayed within services area 802 may include default service links, user specific service links updated automatically by the item information system based upon attributes of advertisement 101 currently being rendered in item information area 101, or user specific service links previously selected by the user from a list of available service links when configuring his/her account.

FIG. 7 illustrates a user display page 900 listing items for which a user has recently entered item codes, in accordance with an embodiment. User display page 900 represents one possible implementation of user display page 45 in FIG. 1. User display page 900 is a sort of consumer queue, personalized collection, or user homepage that may be displayed when the user goes to a website of the item information system. User display page 900 may be displayed after the user logs into the website. The illustrated embodiment of user display page 900 includes an item list region 901, an item archiving region 902, an advertisement display region 903, and service links region 904. The item list region 901 contains an entry for each recently entered item code. Although item list region 901 is illustrated as a textual list, in other embodiment, item list region 901 may be implemented as a graphical collection of the items, in additional or instead of, the illustrated textual list. Each entry may identify the item and item code and further indicate where and when the item code was entered. For example, if the user enters the item code for a DVD via a cell phone, the server records the location and time of entry. The location of entry may be identified from Global Positioning System (GPS) information or other positioning information provided by the cell phone at the time of entry, deduced from cell phone location tracking information, or keyed to the location of the advertisement (e.g., billboard location), and so on. If the advertisement was run in a magazine or newspaper, or run on the television or radio, the location entry may include the name of the magazine or newspaper or the call numbers of the television or radio station. Although not illustrated, the consumer queue may include more or less columns than those illustrated in item list region 901. For example, a promotional column may be added enabling advertisers to add short messages (e.g., promotional offerings, enticements, and related information) associated with each item entry.

When a user selects an entry, the associated advertisement 101 is displayed in advertisement display region 903. If the user double clicks the selected entry or advertisement 101 itself, then the user is linked to the advertiser display page 800. Item archiving region 902 enables the user to organize or otherwise archive entries in item list region 901. Service links region 904 includes links to services related to items in item list area 901, such as links 803-809 described above, or may be configurable by the user. Some of the service links may be persistent links to commonly used services, some may change periodically based on advertiser requests, while still others may automatically change based on the item entries within item list region 901.

The consumer queue within item list region 901 may also be characterized as a universal shopping cart representing a user's commercial interests across a wide variety of products, services or events from various vendors. This universal shopping cart also can be thought of as a commercial or entertainment wish list. Although the embodiments disclosed herein are generally directed to capturing user interests in traditional advertising, it is within the scope of embodiments of the invention that the consumer queue or universal shopping cart can also be populated from online sources and advertisements. The consumer queue or universal shopping cart further facilitates cross product correlations based on the items in the queues of a number of users. These cross product correlations can help advertisers determine consumer interest correlations between products, services, or events for generating targeted advertisements.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a form accessible by a machine (e.g., a computer, network device, personal digital assistant, manufacturing tool, any device with a set of one or more processors that execute instructions, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer implemented method in an item information system for providing item-related information, the method comprising:
receiving coded content at a server submitted by a plurality of users, the coded content corresponding to items of interest to the plurality of users, wherein the coded content includes one or more of a digital file, a digital image, or an alphanumeric code;
organizing the items of interest into item information lists on a per user basis;
enabling the users to share their items of interest with friends or acquaintances via social networking services; and
identifying targeted marketing opportunities by at least analyzing the item information lists of the plurality of users.

2. The computer implemented method of claim 1, wherein analyzing the item information lists of the plurality of users to identify the targeted marketing opportunities comprises:
analyzing the item information lists of the plurality of users to determine cross item correlations between the items in the items information lists between different users; and
determining consumer interest correlations between the plurality of users and the items of interest based upon the cross item correlations to identify potential targeted advertisement opportunities.

3. The computer implemented method of claim 2, further comprising:
soliciting user information, including demographic information, from the plurality of users; and
generating a user mapping of user identifiers to the user information,
wherein determining the consumer interest correlations between the plurality of users and the items of interest includes analyzing the demographic information of each user along with the items of interest associated with each user.

4. The computer implemented method of claim 3, further comprising:
providing statistical information analyzing relations between the demographic information and the items of interest for a fee to advertisers of one or more of the items of interest.

5. The computer implemented method of claim 1, wherein the coded content comprises item codes.

6. The computer implemented method of claim 1, wherein receiving the coded content at the server submitted by the plurality of users comprises receiving the coded content at the server submitted by the plurality of users accessing a website via the Internet.

7. The computer implemented method of claim 1, wherein the items of interest comprise one or more of products, services, or events.

8. The computer implemented method of claim 1, wherein the item information lists comprise personalized graphical collections of the items of interest associated with each of the users.

9. The computer implemented method of claim 2, wherein identifying targeted marketing opportunities comprises:
identifying potential consumers from among the users that may be interested in a given item of interest; and
when a number of the potential consumers identified reaches a threshold number, then soliciting a discount offer from a provider of the given item of interest to be presented to the potential consumers.

10. The computer implemented method of claim 2, wherein identifying targeted marketing opportunities comprises:
presenting a given item of interest identified for a potential discount offer to the users;
soliciting an indication of interest in the potential discount offer for the given item of interest from the users; and
when a number of the users providing the indication of interest reaches a threshold number, then soliciting the potential discount offer from a provider of the given item of interest.

11. The computer implemented method of claim 2, wherein identifying targeted marketing opportunities comprises:
presenting a given item of interest identified for a potential discount offer to the users;
soliciting a conditional commitment to purchase a given item of interest pursuant to the potential discount offer from the users; and
when a number of the users agreeing to the conditional commitment to purchase the given item of interest reaches a threshold number, then soliciting the potential discount offer from a provider of the given item of interest.

12. The computer implemented method of claim 11, wherein the potential discount offer comprises a multi-stage conditional offer that provides greater discounts with greater numbers of conditional commitments by the users.

13. The computer implemented method of claim 11, wherein the potential discount offer expires if the threshold number of the users agreeing to the conditional commitment is not reached within a defined time limit.

14. The computer implemented method of claim 13, wherein the potential discount offers is only offered to a subset of the uses registered to a geographical territory.

15. At least one machine-accessible storage medium providing instructions that, when executed by one or more network computers, will cause the one or more network computers to perform operations comprising:
receiving coded content at a server submitted by a plurality of users, the coded content corresponding to items of interest to the plurality of users, wherein the coded content includes one or more of a digital file, a digital image, or an alphanumeric code;
organizing the items of interest into item information lists on a per user basis;
enabling the users to share their items of interest with friends or acquaintances via social networking services; and
identifying targeted marketing opportunities by at least analyzing the item information lists of the plurality of users.

16. The at least one machine-accessible storage medium of claim 15, wherein analyzing the item information lists of the plurality of users to identify the targeted marketing opportunities comprises:
analyzing the item information lists of the plurality of users to determine cross item correlations between the items in the items information lists between different users; and
determining consumer interest correlations between the plurality of users and the items of interest based upon the cross item correlations to identify potential targeted advertisement opportunities.

17. The at least one machine-accessible storage medium of claim 2, further providing instructions that, when executed by the one or more network computers, will cause the one or more network computers to perform further operations, comprising:
soliciting user information, including demographic information, from the plurality of users; and
generating a user mapping of user identifiers to the user information, wherein determining the consumer interest correlations between the plurality of users and the items of interest includes analyzing the demographic information of each user along with the items of interest associated with each user.

18. The at least one machine-accessible storage medium of claim 17, further providing instructions that, when executed by the one or more network computers, will cause the one or more network computers to perform further operations, comprising:
providing statistical information analyzing relations between the demographic information and the items of interest for a fee to advertisers of one or more of the items of interest.

19. The at least one machine-accessible storage medium of claim 15, wherein the item information lists comprise personalized graphical collections of the items of interest associated with each of the users.

20. The at least one machine-accessible storage medium of claim 16, wherein identifying targeted marketing opportunities comprises:
identifying potential consumers from among the users that may be interested in a given item of interest; and
when a number of the potential consumers identified reaches a threshold number, then soliciting a discount offer from a provider of the given item of interest to be presented to the potential consumers.

21. The at least one machine-accessible storage medium of claim 16, wherein identifying targeted marketing opportunities comprises:
presenting a given item of interest identified for a potential discount offer to the users;
soliciting an indication of interest in the potential discount offer for the given item of interest from the users; and
when a number of the users providing the indication of interest reaches a threshold number, then soliciting the potential discount offer from a provider of the given item of interest.

22. The at least one machine-accessible storage medium of claim 16, wherein identifying targeted marketing opportunities comprises:
presenting a given item of interest identified for a potential discount offer to the users;
soliciting a conditional commitment to purchase a given item of interest pursuant to the potential discount offer from the users; and
when a number of the users agreeing to the conditional commitment to purchase the given item of interest reaches a threshold number, then soliciting the potential discount offer from a provider of the given item of interest.

23. The at least one machine-accessible storage medium of claim 22, wherein the potential discount offer comprises a multi-stage conditional offer that provides greater discounts with greater numbers of conditional commitments by the users.
